(19) United States
(12) Patent Application Publication
(10) Pub. No.: US 2004/0046074 A1
(43) Pub. Date: Mar. 11, 2004

(54) Pendular grinding apparatus

(76) Inventor: Edmond Soudron, Liege (BE)

Correspondence Address: SUGHRUE MION, PLLC, 2100 PENNSYLVANIA AVENUE, N.W., WASHINGTON, DC, 20037, US

(21) Appl. No.: 10/466,829

(22) PCT Filed: Jan. 29, 2002
(86) PCT No.: PCT/BE02/00012

(30) Foreign Application Priority Data
Jan. 29, 2001 (BE) 2001/0069

(51) Int. Cl. B02C 4/28

(52) U.S. Cl. 241/123

(57) ABSTRACT

The invention concerns a pendular grinding apparatus comprising an inner vertical wall (1) rotating about a main vertical axis (2) and forming a runway (3) for grinding, a support (4) coaxially arranged above the runway (3) and designed to be driven in rotation about the main axis, at least two grinding rollers (8) comprising each a rotating surface (9) about an axis of rotation (10) suspended to the support (4) and arranged such that the rotating surface (9) of each roller should run against the runway or against the material to be ground between the roller and said runway (3), a pressing action of each roller (8) on said runway or on said material to be ground supplied between them resulting from a centrifugal force (Fc) of each roller driven in rotation by the support, the grinding apparatus comprising means (12) designed to combine with the centrifugal force (Fc) of each roller an adjustable force and said combining means (12) being supported therefor on a common central element (14) which can be either fixed to the support (4) or be integral therewith.

The present invention relates to a pendular grinder comprising

an internal vertical wall revolving about a main vertical axis and forming a rolling track for grinding;

a support disposed coaxially above the rolling track and arranged in order to be rotated about the main axis; and

at least two grinding rollers. These each comprise a face revolving about an axis of rotation, are suspended from the support and are arranged so that the revolving face of each roller can roll against the rolling track or against material to be ground conveyed between the roller and said track, the roller being able to turn about its axis of rotation, when the common support turns about the main axis. Pressing of each roller on the rolling track or on material to be ground conveyed between them results from a centrifugal force of each roller driven rotationally by the support.

A grinder of this kind is known for example through U.S. Pat. No. 4,522,343.

In a pendular grinder, the grinding pressure is given only by the centrifugal force which the speed of rotation of the support gives to the rollers and which presses these against the rolling track.

The throughput of the known pendular grinder is proportional in particular to the number of rollers used and to the pressing obtained which produces the grinding, and therefore to the centrifugal force Fc which can be calculated as follows:

Fc=m.Ω2.R

The mass m of a roller is approximately given by:

m≅π.d2.h.7850/4

The radius of gyration R of a roller is given by:

R=(D−d)/2

D: diameter of the rolling track (expressed in metres)

d: diameter of the roller (expressed in metres)

h: height of the roller (expressed in metres)

m: mass of the roller (expressed in kg)

Ω: angular speed (expressed in rad/sec)

R: radius of gyration of the centre of gravity of the roller (expressed in metres)

Fc: centrifugal force (expressed in N).

For various reasons, in particular vibrations, the speed of rotation of the rollers must sometimes be limited. The finer the product must be ground, the more limited it is. The result is that, during fine grinding, the centrifugal force reduced by the decrease in the speed of rotation inevitably brings about a large reduction in the throughput of the grinder.

To date, this loss of throughput can be compensated for only by increasing the number of rollers.

An increase in the number of rollers leads to a decrease in their diameter d and therefore their mass. This is, in a small proportion, to the advantage of the radius of gyration (D−d)/2 of the centre of gravity of the roller.

In the known grinder, a loss of mass, due to a decrease in the diameter d of the roller, can be compensated for very partially only by increasing the height h thereof.

The aim of the present invention consists of providing a pendular grinder, the throughput of which can be increased or, if need be, decreased by acting on a parameter other than the speed of rotation, and therefore independently of this speed of rotation and also of the mass of each roller. At the same time, the invention aims to provide a means for adjusting the pressing force of the rollers other than by the speed of rotation.

To that end, the grinder of the invention comprises means arranged for combining, with the centrifugal force of each roller, an adjustable force and these combining means rest to that end on a common central element which can be either fixed to the support or form part thereof.

According to one embodiment of the invention, the combining means comprise, for developing the adjustable force on each roller, a device with fluid, the pressure of which is controlled.

According to one particular embodiment of the invention, the combining means comprise an annular tube made of elastic material, an internal space of which is supplied with fluid at controlled pressure, and an external surface of which is disposed for controlling the pressing of the rollers on the rolling track or on material to be ground.

Other details and specific features of the invention will emerge from the secondary claims and the description of the drawings which accompany the present specifications and which illustrate schematically, by way of non-limiting examples, particular embodiments of the grinder according to the invention.

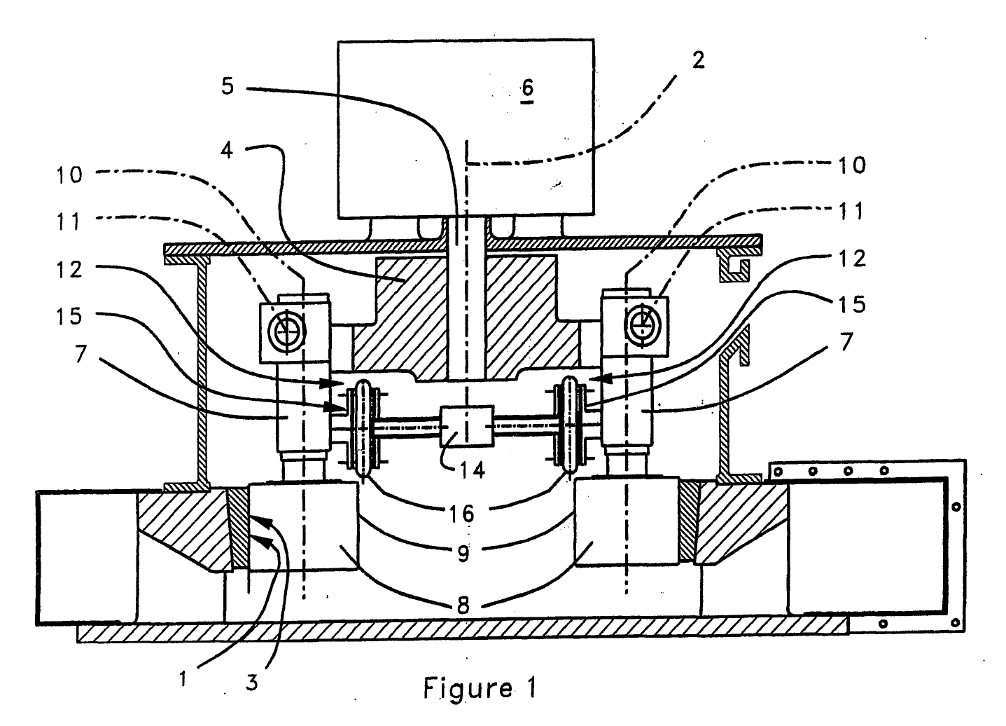

FIGS. 1 to 4 show in elevation and cross-section three different embodiments of the pendular grinder of the invention.

In the different figures, the same reference notations designate identical or analogous elements.

In one embodiment of a pendular grinder, said grinder comprises an internal vertical wall 1 revolving about a main vertical axis 2 and forming a rolling track 3 for grinding. A support 4 is disposed coaxially above the rolling track 3 and is arranged in order to be rotated about the main axis 2 by the shaft 5 of a reduction gear 6. From the support 4, in particular in the form of a star, there are suspended, each time by an arm 7, at least two grinding rollers 8 each comprising a surface 9 revolving about an axis of rotation 10 and arranged do that their revolving face 9 can roll against the rolling track 3, or against material to be ground conveyed between the roller 8 and said track 3, when the support 4 turns about the main axis 2. The roller 8 can then turn about its axis of rotation 10.

Each arm 7 is carried by the support 4 so as to be able to pivot thereon about a horizontal axis of pivot 11. In general, the axes of rotation 10 and of pivot 11 corresponding to one arm 7 do not intersect.

According to the invention, the grinder comprises means 12 arranged for combining, with the centrifugal force of each roller 8, an adjustable force for pressing on the rolling track 3 or on material to be ground conveyed between them. These combining means 12 (FIG. 1) can, if need be, form an assembly supported only by the arms 7 to which they are fixed. This is because the pressing forces as a rule balance each other evenly between the rollers 8.

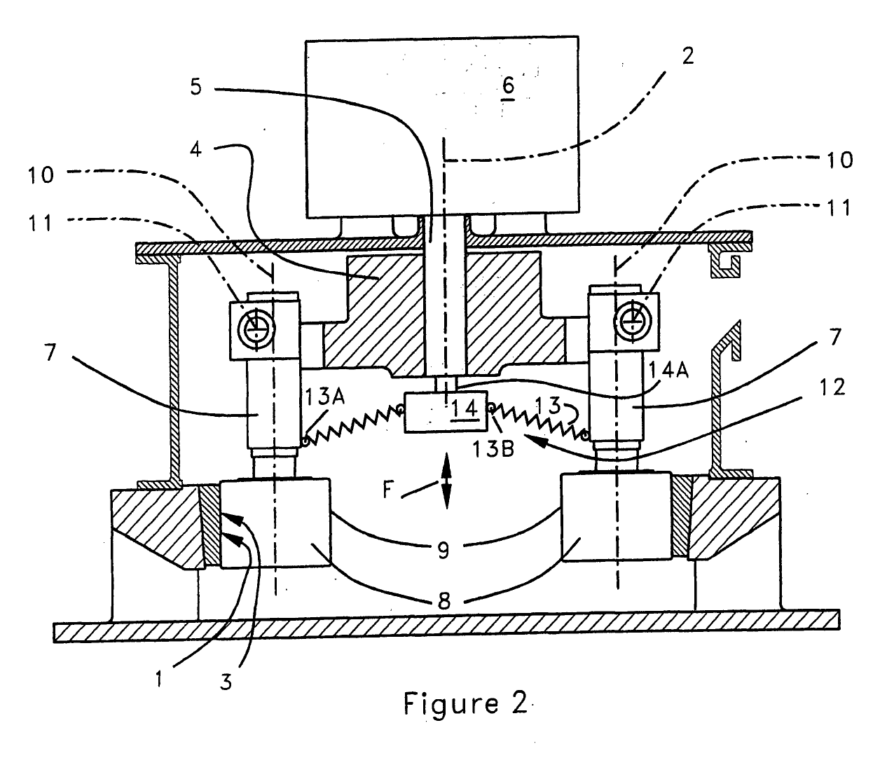

The combining means 12 can however (FIG. 2) rest on the above-mentioned support 4 or form part thereof in order in particular to reduce or avoid transmission of any vibrations from one roller 8 to another.

In the embodiment of FIG. 2, the combining means 12 comprise, for additional pressing of each roller 8, a device with compression springs 13 arranged to act in the same direction as the centrifugal force Fc.

An assembly with draw springs can also be applied to the case where either it is wished for these to push the rollers 8 towards the rolling track, or they are used to reduce the centrifugal force.

One end 13A (FIG. 2) of the springs 13, associated with the rollers 8, can be fixed to the corresponding arm 7 whilst the opposite end 13B of the springs can be fixed to a central element 14. This can form one body with the support 4 or be connected thereto advantageously by an adjustment means 14A arranged in order to be able to move the central element 14, according to a double arrow F, between a first position in which the springs 13 are compressed to a maximum value (the axes of the springs 13 being for example in the same plane as their ends 13A) and a second position in which the springs 13 are compressed to a minimum value or in which they are even relaxed (a position in which the ends 13B are either above or below the aforementioned plane). It is even possible to choose springs 13 and a second position in which they partially oppose the centrifugal force, by pulling on the arms 7.

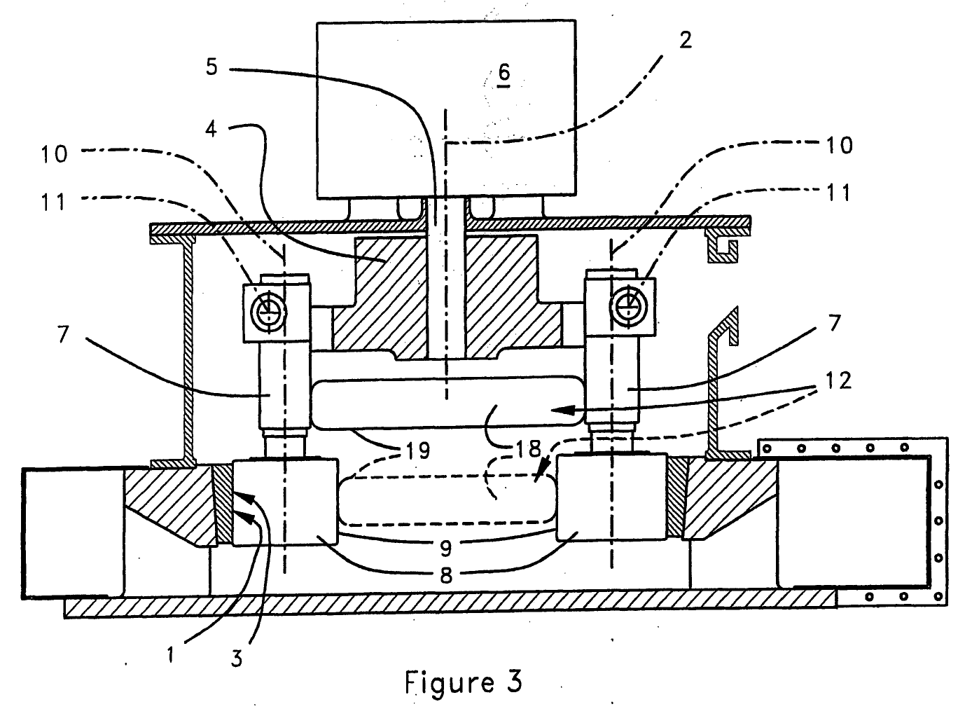

In a preferred embodiment, the combining means 12 comprise for said pressing a device with fluid 15 (FIGS. 1 and 3) acting on the rollers 8, and the pressure of which is controlled according to the desired pressing.

As depicted in FIG. 1, the combining means 12 can comprise, for the pressing of each roller 8, an actuator 16, in particular either of the common type with a cylinder and piston or of a type with bellows, receiving the fluid at controlled pressure.

In a variant and as depicted in FIG. 3, the combining means 12 can comprise an annular tube 18 made of elastic material, an internal space of which is supplied with fluid at controlled pressure, and an external surface 19 of which is disposed for controlling the pressing of the rollers 8 on the rolling track 3 or on material to be ground.

The annular tube 18 can be a standard vehicle tyre, mounted on a wheel, also standard, acting as the central element 14.

In a proposed assembly in solid lines in FIG. 3, the external surface 19 of the annular tube acts on each roller 8 by means of the arm 7 carrying this roller 8. In this case, said tube 18 can be fixed to the support 4 and turn therewith.

On the other hand, in a variant depicted in broken lines in FIG. 3, the external surface 19 of the annular tube 18 acts on the revolving surface 9 of the rollers. The annular tube 18 must be able to turn with respect to the support 4.

In particular in the case of an actuator 16 with cylinder and piston or with bellows, the combining means 12 can be arranged to both pressurise the control fluid and depressurise it. In the latter situation, there is thus the possibility of substantially increasing, for a given material, the speed of rotation Ω of the rollers 8 in order to increase the throughput of ground material, without for this increasing, up to values harmful to this material, the pressing force of the rollers 8 during the grinding. This is because the force obtained by reducing the pressure in each actuator 16 is subtracted from the centrifugal force Fc corresponding to the chosen speed Ω.

It must be understood that the invention is in no way limited to the embodiments described and that many modifications can be made thereto without departing from the scope of the claims.

Thus, there should be considered, as a technical equivalent of the system with pressure reduction which has just been described, a non-depicted assembly in which each roller 8 is pushed towards the rolling track 3 by a corresponding actuator 16, or by the annular tube 18, supplied with adjustable pressure, and is pulled in the opposite direction by a spring, not depicted. It is easy to understand that, in this case also, the centrifugal force Fc is opposed by the force of said spring which can be considered as substantially constant for the path it travels in following the movement of the arm 7. The actuator 16 or tube 18 thus adds its adjustable force to the centrifugal force Fc in order to obtain an adjustment of the resultant grinding pressing force.

In the pendular grinder of the invention, a limit stop system, not depicted, can be provided to act for example on each arm 7 in order to keep the rollers 8 at a desired distance from the rolling track 3, in order in this way to determine a grinding fineness.

It should be noted that one aim of the invention consists in addition in that the resultant of the forces applied to the central element 14 and/or the support 4 is zero, among other things a balance being obtained automatically in the fluid-based systems described above.

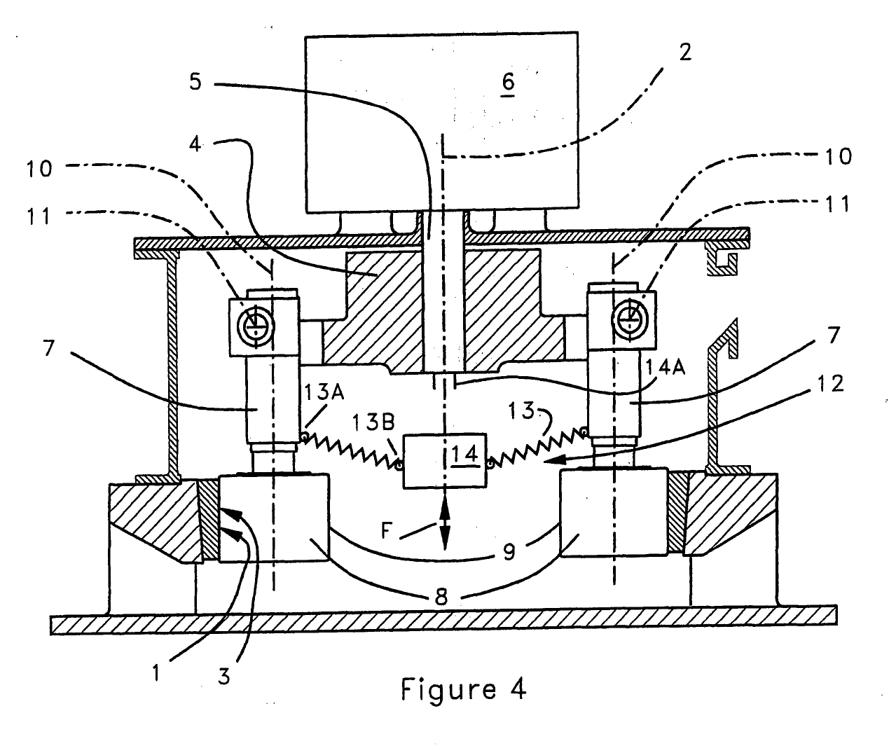

FIG. 4 shows a variant embodiment of the grinder with springs 13 depicted in FIG. 2.

In the case of FIG. 4, the central element 14 can be moved by the adjustment means 14A according to the double arrow F from a low position (depicted) in which the springs 13 are either compressed to a minimum value, or relaxed, or even in traction in order to oppose the centrifugal force. In particular the weight of the central element 14, possibly reinforced by a spring or a return actuator, can determine the force which pulls it into the depicted low position. In order to adjust the action of the springs 13 on the arms 7 and therefore on the rollers 8 in combination with the centrifugal force, it is sufficient to subject the adjustment means 14A to traction in order to raise the central element 14 by the desired value and thus progressively go for example from traction exerted by the springs 13 on the arms 7 to a chosen compression.

Advantageously in the case of FIG. 4, the adjustment means 14A is subjected to traction and does not risk buckling, even if it has a small cross-section, unlike the case of the adjustment means 14A of FIG. 2 which is compressed in order to increase the compressive force of the springs 13 combining with the centrifugal force.

1. Pendular grinder comprising:
an internal vertical wall (1) revolving about a main vertical axis (2) and forming a rolling track (3) for grinding;
a support (4) disposed coaxially above the rolling track (3) and arranged in order to be rotated about the main axis (2);
at least two grinding rollers (8), each comprising a face (9) revolving about an axis of rotation (10), suspended from the support (4) and arranged so that the revolving face (9) of each roller (8) can roll against the rolling track (3) or against material to be ground conveyed between the roller (8) and said track (3), the roller (8) being able to turn about its axis of rotation (10), when the support (4) turns about the main axis (2);
pressing of each roller (8) on the rolling track (3) or on material to be ground conveyed between them resulting from a centrifugal force (Fc) of each roller (8) driven rotationally by the support (4), the grinder being characterised in that it comprises means (12) arranged for combining, with the centrifugal force (Fc) of each roller (8), an adjustable force, and in that these combining means (12) rest to that end on a common central element (14) which can be either fixed to the support (4) or form part thereof.

2. Grinder according to claim 1, characterised in that the combining means (12) comprise, for each roller (8), a device with springs (13) arranged preferably so as to push the roller (8) in the same direction as the centrifugal force (Fc).

3. Grinder according to claim 2, characterised in that, at their end (13B) opposite to the one (13A) associated with a roller (8) to be controlled, the springs (13) of the different rollers (8) are fixed to the central element (14) connected to the aforementioned support (4) by an adjustment means (14A) arranged in order to be able to move said central element (14A) between a position in which the springs (13) are compressed to a maximum value and a position in which they are compressed to a minimum value, perhaps even relaxed or in traction.

4. Grinder according to either of claims 1 or 2, characterised in that the combining means (12) comprise, for developing the adjustable force on each roller (8), a device with fluid (15), the pressure of which is controlled.

5. Grinder according to claim 4, characterised in that the device with fluid (15) comprises, for each roller (8), an actuator (16) receiving the fluid at controlled pressure.

6. Grinder according to claim 5, characterised in that, at their end opposite to the one associated with a roller (8) to be controlled, the actuators (16) of the different rollers (8) are fixed to the central element (14) possibly fixed to the above-mentioned support (4).

7. Grinder according to claim 4, characterised in that the combining means (12) comprise an annular tube (18) made of elastic material, an internal space of which is supplied with fluid at controlled pressure, and an external surface (19) of which is disposed for controlling the pressing of the rollers (8) on the rolling track (3) or on material to be ground.

8. Grinder according to claim 7, characterised in that the external surface (19) of the annular tube (18) acts on each roller (8) by means of an arm (7) carrying this roller (8).

9. Grinder according to claim 7, characterised in that the external surface (19) of the annular tube (18) acts on the revolving surface (9) of the rollers (8).

10. Grinder according to any one of claims 4 to 9, characterised in that the device with fluid (15) is arranged to pressurise or depressurise the control fluid.

11. Grinder according to any one of claims 1 to 10, characterised in that a limit stop system is arranged to act on each arm (7) in order to keep the rollers (8) at a desired distance from the rolling track (3).

12. Grinder according to any one of claims 1 to 11, characterised in that the combining means (12) are arranged so that the resultant of the applied forces for each arm (7) is zero at the location of the central element (14) and/or the support (4).
